(19) United States
(12) Patent Application Publication
(10) Pub. No.: US 2018/0100625 A1
(43) Pub. Date: Apr. 12, 2018

(54) LED LIGHT BULB AND FABRICATION METHOD THEREOF

(71) Applicant: Double Good Co., Hsinchu County (TW)

(72) Inventor: SZU-MIN FAN, Hsinchu County (TW)

(21) Appl. No.: 15/291,683

(22) Filed: Oct. 12, 2016

(51) Int. Cl. F21K 9/238; F21K 9/232; F21K 9/235; F21V 3/04; F21V 23/00; F21K 9/90

(52) U.S. Cl. CPC F21K 9/238; F21K 9/232; F21K 9/235; F21Y 2115/10; F21V 23/005; F21V 23/002; F21K 9/90; F21V 3/0418

(57) ABSTRACT

An LED light bulb and a fabrication method thereof are provided. An LED circuit board for driving an LED filament are fixed to form a supporting structure for supporting and fixing the LED filament in position, without using a stem of a conventional LED light bulb, thereby simplifying fabrication processes of the LED light bulb and reducing fabrication costs thereof. Moreover, the LED light bulb does not require an internal space for accommodating the stem, and thus its length can be effectively reduced to ideally become a small-size light bulb.

### BACKGROUND OF THE INVENTION

### Field of the Invention

The invention relates to lighting fields, and more particularly, to an LED light bulb and a fabrication method thereof.

### Descriptions of the Related Art

It is known that light-emitting diode (LED) light bulbs have many advantages such as lasting longer, more energy-efficient, more environmental friendly and reacting more rapidly, which make LED lighting gradually replace traditional lighting.

A fabrication method of a conventional LED light bulb is shown in FIG. 1. First in step S21, a stem 21, an LED filament 22 and two power wires 23 shown in FIG. 2a are provided. The stem 21 is used to support the LED filament 22. The stem 21 includes an exhaust tube 211 and a horn-shaped tube 212, wherein the exhaust tube 211 and the two power wires 23 pass through the horn-shaped tube 212. Then in step S22, as shown in FIG. 2b, two ends of the LED filament 22 are soldered to the two power wires 23 passing through the stem 21 to form a semi-finished LED light bulb 24. Then in step S23, as shown in FIG. 2c, a glass envelope 25 is provided to cover and protect a head part of the semi-finished LED light bulb 24. Then in step S24, as shown in FIG. 2d, a sealer is used to seal the glass envelope 25, and an exhausting machine is used to discharge redundant gas from the glass envelope 25 through the exhaust tube 211. Then in step S25, any unnecessary portion of the exhaust tube 211 is removed, and a screw base 26 is provided, making the two power wires 23 electrically connected to the screw base 26 respectively, thereby forming a finished LED light bulb 2 shown in FIG. 2e.

Therefore in the conventional LED light bulb 2, the stem 21 must be provided to support the LED filament 22, making the fabrication method of the LED light bulb 2 complicated and not cost-effective. As shown in FIG. 2e, the LED light bulb 2 also requires an internal space for accommodating a front end 213 of the stem 21, such that the LED light bulb 2 cannot be significantly reduced in length and cannot replace all the small-size traditional light bulbs.

### SUMMARY OF THE INVENTION

In view of the shortages of prior technologies mentioned above, the invention provides an LED filament, which is a strip and has two ends respectively formed with a positive electrode and a negative electrode; an LED circuit board for supporting the LED filament, wherein the LED circuit board has an LED drive circuit for driving the LED filament, and a first end for being electrically connected to the positive electrode and the negative electrode respectively; a glass envelope having an upper part formed with an internal space therein and a lower part formed with a passage therethrough, wherein the LED filament is allowed to pass through the passage and enter the internal space until the LED circuit board is engaged with the lower part of the glass envelope such that the LED filament is positioned in the internal space; a power wire set for being electrically connected to a second end of the LED circuit board, and for receiving power and supplying electricity to the LED drive circuit; and a screw base for being electrically connected to the power wire set that is extended to an inner wall of the screw base.

Optionally, the power wire set is extended from the LED circuit board to the inner wall of the screw base.

Optionally, the power wire set includes two power wires, which are made of copper, iron or galvanized iron.

Optionally, the screw base includes a threaded cap, an electrical contact and an insulator, wherein the electrical contact is located under the threaded cap, the insulator electrically isolates the threaded cap from the electrical contact, and the two power wires are soldered to the threaded cap and the electrical contact respectively.

Optionally, the LED circuit board and the LED filament are extended towards a passage surface substantially vertical to an extension direction of the passage.

Optionally, the positive electrode of the LED filament is soldered to the LED circuit board, and the LED light bulb further includes a bonding wire having two ends respectively soldered to the LED circuit board and the negative electrode of the LED filament so as to form electrical connection between the LED circuit board and the negative electrode.

Moreover, the invention further provides a fabrication method of an LED light bulb, including the steps of: providing an LED filament, an LED circuit board and a power wire set, wherein the LED filament is a strip having two ends formed with electrodes respectively, the LED circuit board includes an LED drive circuit for driving the LED filament, and the power wire set is electrically connected to the LED circuit board and for receiving power and supplying electricity to the LED drive circuit; electrically connecting the LED filament to the LED circuit board, for allowing the LED circuit board to support and drive the LED filament; providing a glass envelope, the glass envelope having an internal space formed therein and a passage formed therethrough; allowing the LED filament to pass through the passage and enter the internal space until the LED circuit board is engaged with the glass envelope so as to position the LED filament in the internal space; and providing a screw base, and allowing the power wire set to be extended to an inner wall of the screw base and soldered to the screw base, so as to electrically connect the power wire set and the screw base.

Optionally, the LED filament is electrically connected to the LED circuit board by soldering.

Optionally, the fabrication method further including a step of providing an adhesive for attaching the screw base to the glass envelope after the power wire set is electrically connected to the screw base.

Optionally, the fabrication method further including a step of providing a bonding wire for bonding the LED filament to the LED circuit board, so as to electrically connect the LED filament to the LED circuit board.

Compared to the conventional technology, the present invention provides an LED light bulb and a fabrication method thereof, which advantageously do not require a stem or gas-filling, sealing and gas-exhausting procedures for the LED light bulb, such that the fabrication processes of the LED light bulb are simplified. The LED light bulb may be manufactured by machines or manual assembly, and its fabrication costs are thereby reduced. Moreover, provided that no stem is needed, the LED light bulb of the invention does not require an internal space for accommodating the stem, and thus its length may be significantly reduced, making the LED light bulb ideally used as a small-size light bulb.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart showing a fabrication method of a conventional LED light bulb.

FIGS. 2a to 2e are schematic diagrams showing an embodiment of the LED light bulb fabricated by the steps shown in FIG. 1.

FIG. 3 is a flowchart showing a fabrication method of an LED light bulb according to the invention.

FIGS. 4a to 4h are schematic diagrams showing an embodiment of the LED light bulb fabricated by the steps shown in FIG. 3.

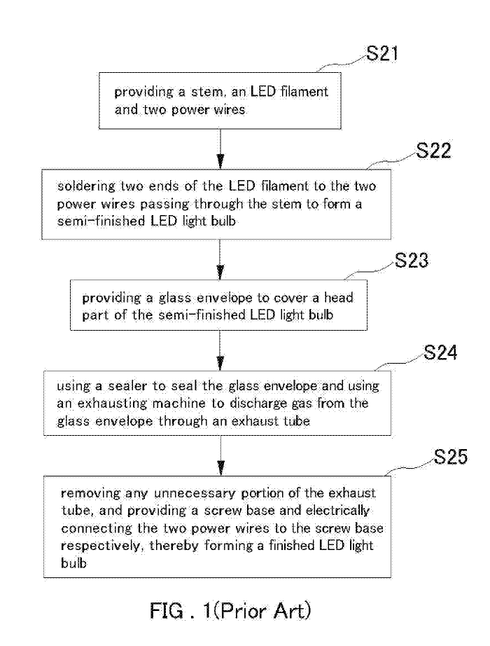

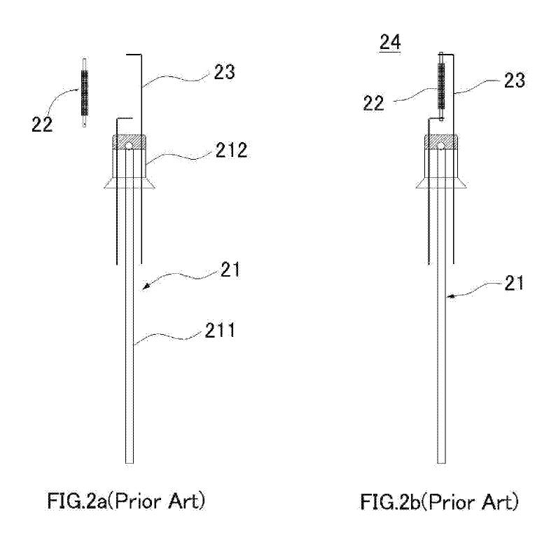

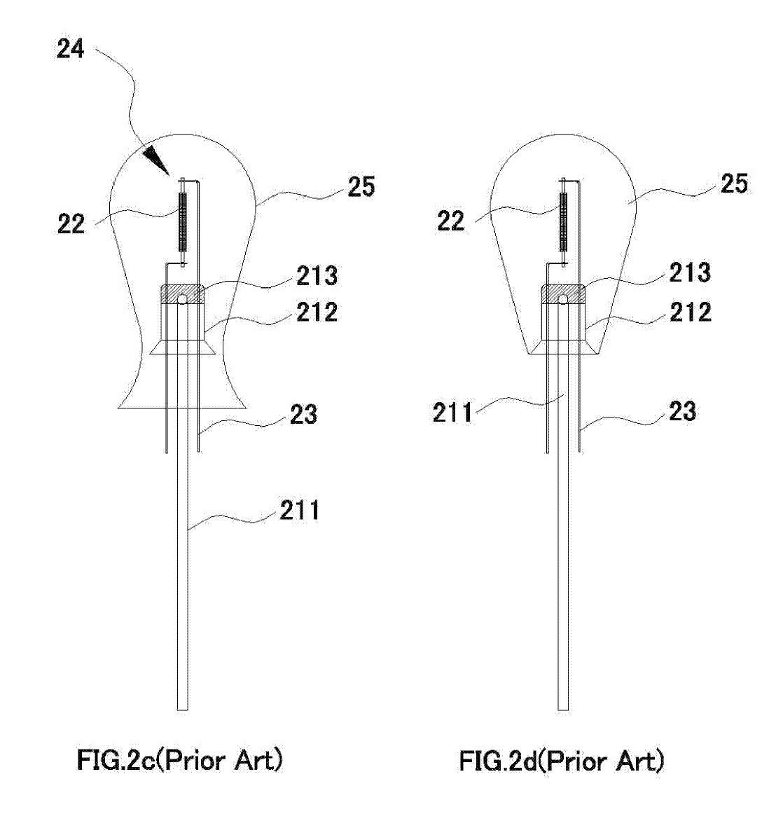

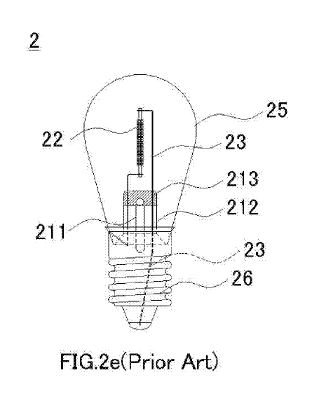

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

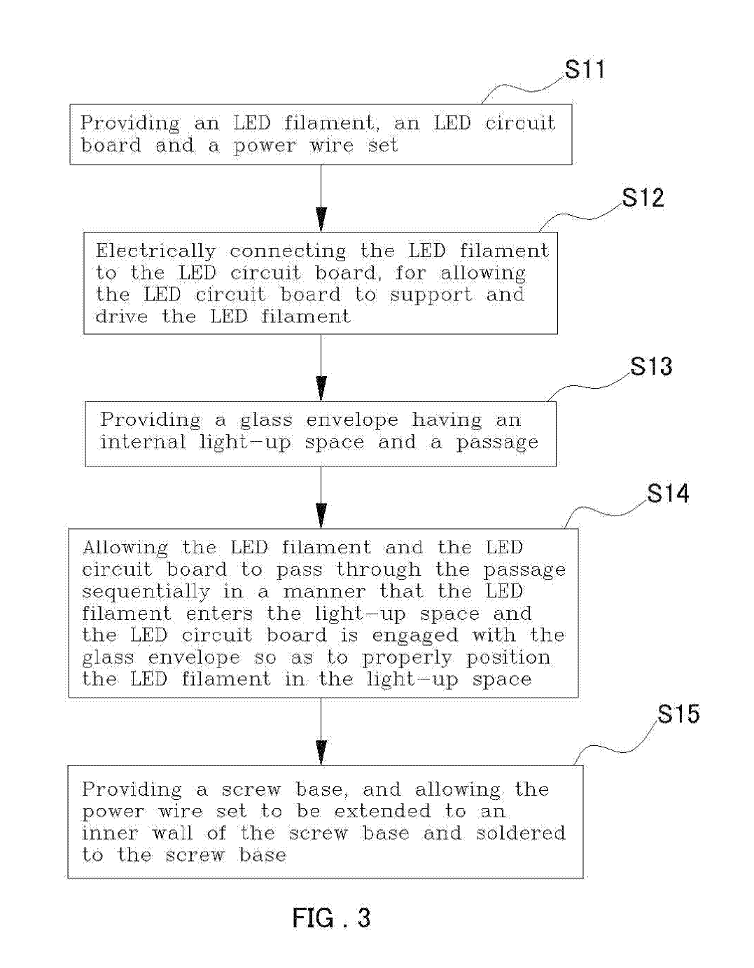

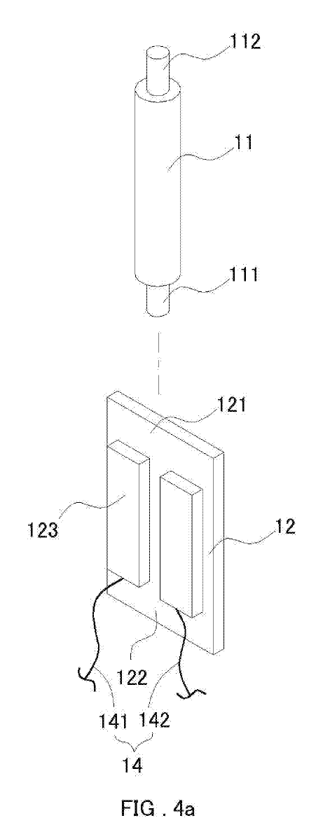

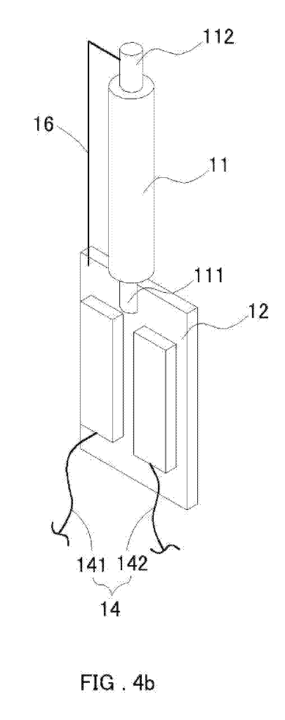

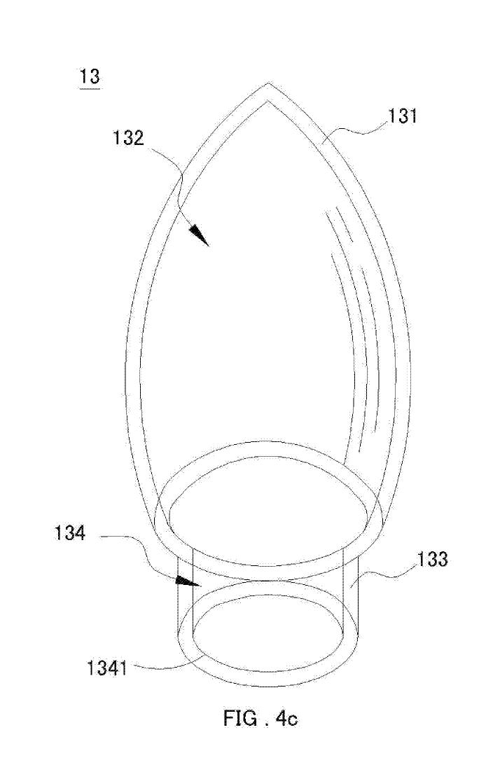

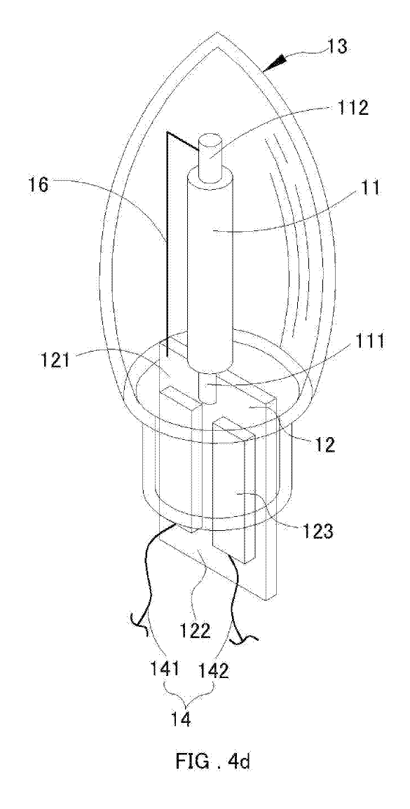

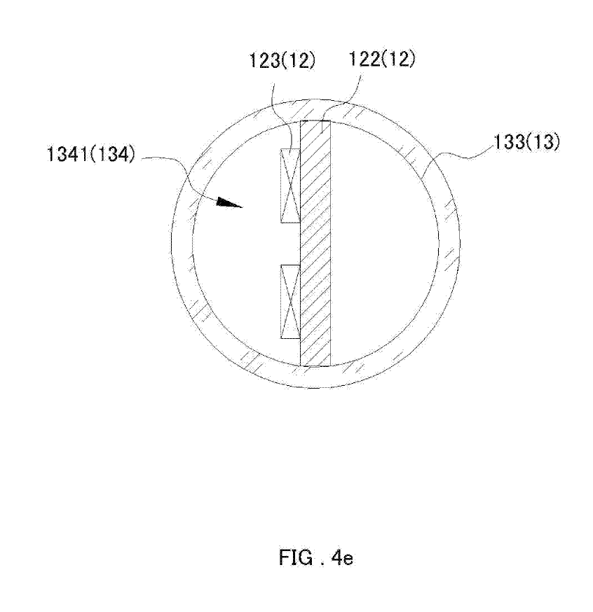

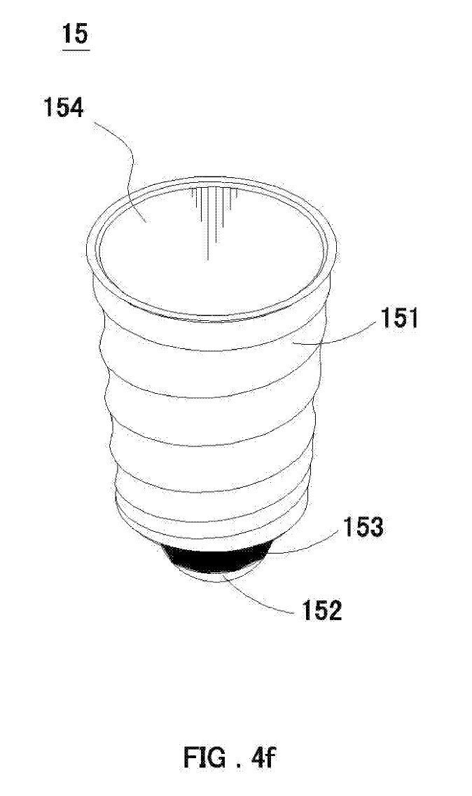

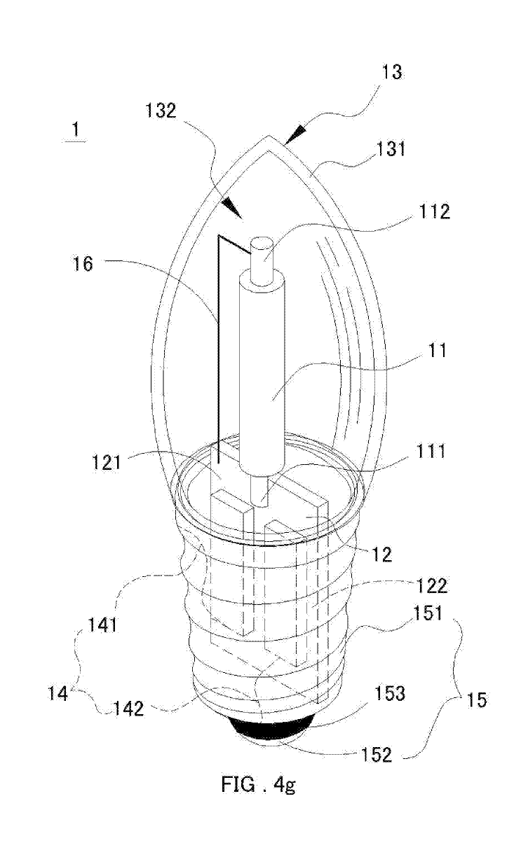

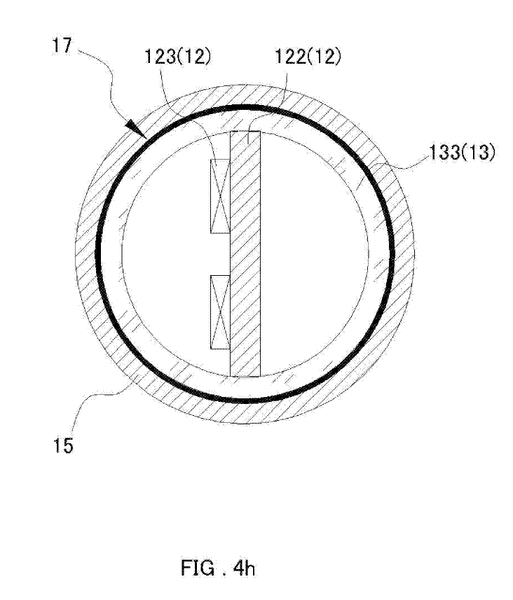

An LED light bulb and a fabrication method thereof provided in the invention are described as follows with reference to FIGS. 3 and 4a to 4h.

The LED light bulb of the invention can be fabricated by the following steps. First in step S11, as shown in FIG. 4a, an LED filament 11, an LED circuit board 12 and a power wire set 14 are provided. The LED filament 11 is extended to have one end formed with a positive electrode 111 and the other end formed with a negative electrode 112. The LED circuit board 12 includes an LED drive circuit 123 for driving the LED filament 11; that is, the LED drive circuit 123 may drive the LED filament 11 to light up. The power wire set 14 is electrically connected to a second end 122 of the LED circuit board 12, and is used to supply electricity to the LED drive circuit 123 when the power wire set 14 receives power. The power wire set 14 may be an electrical conductor made of copper, iron or galvanized iron, and includes two power wires 141, 142.

Then in step S12, as shown in FIG. 4b, the positive electrode 111 and the negative electrode 112 of the LED filament 11 are electrically connected to a first end 121 of the LED circuit board 12, wherein the LED circuit board 12 may support and drive the LED filament 11. This forms a semi-finished LED light bulb. Further in step S12, a bonding wire 16 may be provided to bond the LED filament 11 to the LED circuit board 12, so as to form electrical connection between the LED filament 11 and the LED circuit board 12. Referring to FIG. 4b, the positive electrode 111 of the LED filament 11 is directly soldered to the LED circuit board 12, and the bonding wire 16 has its two ends respectively soldered to the LED circuit board 12 and the negative electrode 112 of the LED filament 11, so as to form electrical connection between the LED circuit board 12 and the negative electrode 112. The invention is not limited to such embodiment. Alternatively, for example, the negative electrode 112 of the LED filament 11 may be directly soldered to the LED circuit board 12, and the two ends of the bonding wire 16 are respectively soldered to the LED circuit board 12 and the positive electrode 111 of the LED filament 11.

In step S13, as shown in FIG. 4c, a bulb machine is utilized to provide a glass envelope 13. The glass envelope 13 includes an upper part 131 formed with an internal space 132 therein, and a lower part 133 formed with a passage 134 therethrough.

In step S14, as shown in FIGS. 4d and 4e, the LED filament 11 is allowed to pass through the passage 134 and enter the internal space 132 of the glass envelope 13 until the LED circuit board 12 is structurally engaged and interferes with the lower part 133 of the glass envelope 13, such that the LED filament 11 is properly positioned in the internal space 132 and is protected by the glass envelope 13. In such case, gas-filling, sealing and gas-exhausting procedures are not required for the glass envelope 13 of the invention, thereby simplifying the fabrication processes of the LED light bulb 1. This makes the LED light bulb 1 able to be manufactured by machines or manual assembly. Selectively, the LED circuit board 12 and the LED filament 11 are extended towards a passage surface 1341 substantially vertical to an extension direction of the passage 134.

In step S15, as shown in FIGS. 4g and 4f, a screw base 15 is provided, and the power wire set 14 is extended to an inner wall 154 of the screw base 15 and soldered to the screw base 15. Then, a filling machine is utilized to fill an adhesive 17 in the screw base 15 as shown in FIG. 4h, so as to adhere the screw base 15 to the lower part 133 of the glass envelope 13, thereby forming a finished LED light bulb. As shown in FIG. 4g, the power wire set 14 includes two power wires 141, 142. The screw base 15 includes a threaded cap 151, an electrical contact 152 and an insulator 153. The electrical contact 152 is located under the threaded cap 151. The insulator 153 is used to electrically isolate the threaded cap 151 from the electrical contact 152. The two power wires 141, 142 are respectively soldered to the threaded cap 151 and the electrical contact 152.

The LED light bulb of the invention has a structure shown in FIGS. 4g to 4h, wherein FIG. 4e is a bottom view of FIG. 4d, and FIG. 4h is a cross-sectional view of a screw base in FIG. 4g. The LED light bulb 1 includes: an LED filament 11, an LED circuit board 12, a glass envelope 13, a power wire set 14 and a screw base 15. The LED filament 11 is extended to have a positive electrode 111 and a negative electrode 112. The LED circuit board 12 provides support for the LED filament 11. It has an LED drive circuit 123 for driving the LED filament 11, and a first end 121 for being electrically connected to the positive electrode 111 and the negative electrode 112 respectively. The glass envelope 13 has an upper part 131 formed with an internal space 132 therein, and a lower part 133 formed with a passage 134 therethrough. The LED filament 11 may pass through the passage 134 into the internal space 132 until the LED circuit board 12 structurally interferes with the lower part 133 of the glass envelope 13, such that the LED filament 11 is properly positioned in the internal space 132. The LED circuit board 12 further has a second end 122 for being electrically connected to the power wire set 14. The screw base 15 is used to electrically connect an external power. The power wire set 14 is extended from the LED circuit board 12 through the passage 134 to an inner wall 154 of the screw base 15 and is electrically connected to the screw base 15, such that the power wire set 14 may receive power through the screw base 15 and supply electricity to the LED drive circuit 123.

As described above, the invention provides an LED light bulb and a fabrication method thereof, which use structural interference to engage the LED circuit board with the glass envelope so as to properly support and position the LED filament. Therefore in the invention, there is no need to perform gas-filling, sealing and gas-exhausting procedures on the glass envelope, such that the fabrication processes of the LED light bulb are simplified, and also the LED light bulb may be manufactured by machines or manual assembly.

The examples above are only illustrative to explain principles and effects of the invention, but not to limit the invention. It will be apparent to those skilled in the art that modifications and variations can be made without departing from the scope of the invention. Therefore, the protection range of the rights of the invention should be as defined by the appended claims.

What is claimed is:

1. An LED light bulb (1), including:
an LED filament (11), which is a strip and has two ends respectively formed with a positive electrode (111) and a negative electrode (112);
an LED circuit board (12) for supporting the LED filament (11), wherein the LED circuit board (12) has an LED drive circuit (123) for driving the LED filament (11), and a first end (121) for being electrically connected to the positive electrode (111) and the negative electrode (112) respectively;
a glass envelope (13) having an upper part (131) formed with an internal space (132) therein and a lower part (133) formed with a passage (134) therethrough, wherein the LED filament (11) is allowed to pass through the passage (134) and enter the internal space (132) until the LED circuit board (12) is engaged with the lower part (133) of the glass envelope (13) such that the LED filament (11) is positioned in the internal space (132);
a power wire set (14) for being electrically connected to a second end (122) of the LED circuit board (12), and for receiving power and supplying electricity to the LED drive circuit (123); and
a screw base (15) for being electrically connected to the power wire set (14) that is extended to an inner wall (154) of the screw base (15).

2. The LED light bulb (1) according to claim 1, wherein the power wire set (14) is extended from the LED circuit board (12) to the inner wall (154) of the screw base (15).

3. The LED light bulb (1) according to claim 1, wherein the power wire set (14) includes two power wires (141, 142), which are made of copper, iron or galvanized iron.

4. The LED light bulb (1) according to claim 3, wherein the screw base (15) includes a threaded cap (151), an electrical contact (152) and an insulator (153), wherein the electrical contact (152) is located under the threaded cap (151), the insulator (153) electrically isolates the threaded cap (151) from the electrical contact (152), and the two power wires (141, 142) are soldered to the threaded cap (151) and the electrical contact (152) respectively.

5. The LED light bulb (1) according to claim 1, wherein the LED circuit board (12) and the LED filament (11) are extended towards a passage surface (1341) substantially vertical to an extension direction of the passage (134).

6. The LED light bulb (1) according to claim 1, wherein the positive electrode (111) of the LED filament (11) is soldered to the LED circuit board (12), and the LED light bulb (1) further includes a bonding wire (16) having two ends respectively soldered to the LED circuit board (12) and the negative electrode (112) of the LED filament (11) so as to form electrical connection between the LED circuit board (12) and the negative electrode (112).

7. A fabrication method of an LED light bulb (1), including the steps of:
providing an LED filament (11), an LED circuit board (12) and a power wire set (14), wherein the LED filament (11) is a strip having two ends formed with electrodes respectively, the LED circuit board (12) includes an LED drive circuit (123) for driving the LED filament (11), and the power wire set (14) is electrically connected to the LED circuit board (12) and for receiving power and supplying electricity to the LED drive circuit (12);
electrically connecting the LED filament (11) to the LED circuit board (12), for allowing the LED circuit board (12) to support and drive the LED filament (11);
providing a glass envelope (13), the glass envelope (13) having an internal space (132) formed therein and a passage (134) formed therethrough;
allowing the LED filament (11) to pass through the passage (134) and enter the internal space (132) until the LED circuit board (12) is engaged with the glass envelope (13) so as to position the LED filament (11) in the internal space (132); and
providing a screw base (15), and allowing the power wire set (14) to be extended to an inner wall (154) of the screw base (15) and soldered to the screw base (15), so as to electrically connect the power wire set (14) and the screw base (15).

8. The fabrication method according to claim 7, wherein the LED filament (11) is electrically connected to the LED circuit board (12) by soldering.

9. The fabrication method according to claim 7, further including a step of providing an adhesive (17) for attaching the screw base (15) to the glass envelope (13) after the power wire set (14) is electrically connected to the screw base (15).

10. The fabrication method according to claim 7, further including a step of providing a bonding wire (16) for bonding the LED filament (11) to the LED circuit board (12), so as to electrically connect the LED filament (11) to the LED circuit board (12).
